(19) United States
(12) Patent Application Publication
(10) Pub. No.: US 2012/0045957 A1
(43) Pub. Date: Feb. 23, 2012

(54) FIBER COATED NONWOVEN LAMINATES AND METHODS AND LINES FOR MAKING THE SAME

(76) Inventors: Peter Ping-Yi Tsai, Knoxville, TN (US); Clifton Woods, III, Knoxville, TN (US); Jack Louis Wyrick, Knoxville, TN (US)

(21) Appl. No.: 12/859,024

(22) Filed: Aug. 18, 2010

(51) Int. Cl. B32B 5/24; B32B 27/12; B29C 47/06

(52) U.S. Cl. 442/370; 264/211.12; 442/394; 425/174.8 E

(57) ABSTRACT

Fiber coated nonwoven laminates and methods and lines for making the same are disclosed. The fiber coated nonwoven laminates can have a fiber web layer that can range from about 0.01 g/m² to about 100 g/m². The lines for forming the nonwoven laminates can include a die body that includes an extruder therein for extruding fibers and a collector disposed below the die body. A substrate feeder can be provided for directing a substrate over the collector between the die body and the collector. The substrate is combinable with the extruded fibers to form the nonwoven laminate. An electric field can be created between the die body and collector to direct the fibers toward the collector as the substrate passes over the collector to collect the fibers on the substrate.

### TECHNICAL FIELD

The presently disclosed subject matter relates, in general, to nonwoven laminates and methods and lines for making the same. More particularly, the presently disclosed subject matter relates to fiber coated nonwoven laminates and methods and lines for making the same, wherein the fibers can be directed to the substrate through the use of an electric field.

### BACKGROUND

Spunbonded or meltblown processes can be used to create nonwoven webs. Air suction on a web former of a spunbonded or a meltblown line is a common way to collect fibers to form a nonwoven web. The suction is also used to assist in uniformly distributing fibers to form more uniform webs. The suction force compacts the fibers to make more compact or less porous webs. However, some applications, such as air filter media, require more porous webs to reduce the air resistance through the webs.

Usually, in meltblown processes, web porosity is achieved by increasing the distance between a die body through which polymer is extruded to form fibers and the surface on which the fibers are collected. However, in such meltblown lines, serious problems can occur with the meltblown webs being formed due to uneven distribution of the fibers. In particular, the non-uniform distribution can cause defects, such as “ropes” to increase. Additionally, when a low-permeability substrate or a substrate that has no permeability, such as microporous films or electrospun nano-fiber membranes, is used, the use of air suction does not facilitate the collection of fibers on the substrate.

### SUMMARY

According to present disclosure, fiber coated nonwoven laminates and methods and lines of making the same are provided. It is, therefore, an object of the present disclosure to provide fiber coated nonwoven laminates that comprise a substrate on which fibers are attached, and to provide methods and lines of making the same. For example, a substrate can collect fibers thereon to form the fiber coated nonwoven laminate by having the fibers pass through an electric field to direct the fibers toward the substrate as it passes over a collector.

This and other objects of the present disclosure as can become apparent from the present disclosure are achieved, at least in whole or in part, by the subject matter described herein.

### BRIEF DESCRIPTION OF THE DRAWINGS

A full and enabling disclosure of the present subject matter including the best mode thereof to one of ordinary skill of the art is set forth more particularly in the remainder of the specification, including reference to the accompanying figures in which:

FIG. 1 illustrates a vertical cross-sectional schematic view of at least a portion of an embodiment of a line for creating a nonwoven laminate according to the present subject matter;

FIG. 2 illustrates a vertical cross-sectional schematic view of at least a portion of the embodiment of a line for creating a nonwoven laminate according to FIG. 1 with no electric field created;

FIG. 3 illustrates a vertical cross-sectional schematic view of at least a portion of the embodiment of a line for creating a nonwoven laminate according to FIG. 1 with an electric field created according to the present subject matter;

FIG. 4 illustrates a vertical cross-sectional schematic view of at least a portion of the embodiment of a line for creating a nonwoven laminate according to FIG. 1 with an electric field created according to the present subject matter;

FIG. 5 illustrates a vertical cross-sectional schematic view of at least a portion of the embodiment of a line for creating a nonwoven laminate according to FIG. 1 with an electric field created according to the present subject matter;

FIG. 6 illustrates a vertical cross-sectional schematic view of at least a portion of the embodiment of a line for creating a nonwoven laminate according to the present subject matter;

FIG. 7 illustrates a vertical cross-sectional schematic view of at least a portion of an embodiment of a line for creating a nonwoven laminate according to the present subject matter; and

FIG. 8 illustrates a vertical cross-sectional schematic view of at least a portion of an embodiment of a spunbonding line for creating a nonwoven laminate according to the present subject matter.

### DETAILED DESCRIPTION

Reference will now be made in detail to possible embodiments of the present subject matter, one or more examples of which are shown in the figures. Each example is provided to explain the subject matter and not as a limitation. In fact, features illustrated or described as part of one embodiment can be used in another embodiment to yield still a further embodiment. It is intended that the subject matter disclosed and envisioned herein covers such modifications and variations.

According to the present subject matter, fibers can be collected on substrates with electrical charges on the fibers and/or electric field to create fiber coated nonwoven laminate that can have a fiber web layer thereon. The weight per unit area of the fiber web layer can be in the range of about 0.5 gram per square meter (hereinafter “gsm”) to about 100 gsm. Thus, such weights of about 0.5 gsm to about 5 gsm for fiber web layers in the fiber coated nonwoven laminate can be achieved that are not achievable with such nonwoven laminates when adhesives are used. The fibers can be collected on the substrate through the use of electrical charges on the fibers and/or an electric field between the die body and the charging device, the charging device and the collector, or between the die body and the collector without the charging device. Optimal and/or desirable electrostatic charging of the fibers and optimal and/or desirable electric field can be achieved by adjusting the voltages on the charging device and the collector depending on the processing parameters such as the primary air velocity, the distance between the die body to the collector, and the polymer throughput.

A line for forming a nonwoven laminate according to the present subject matter is provided. The line can comprise a die body that includes an extruder therein for extruding fibers. For example, the die body can be a die body configured to produce spunbonded fibers or meltblown fibers. The die body can be grounded or charged. When the die body is charged, it can also be electrically isolated. The line can comprise a collector disposed below the die body for collecting the fibers extruded therefrom. In some embodiments according to the present subject matter, the collector can have a voltage applied thereto to create an electrode. In other embodiments, the collector can be grounded. The collector can comprise many structures. For example, the collector can be a rotatable drum or a belt web former.

The line can comprise a substrate feeder for directing a substrate over the collector between the die body and the collector. Such a substrate can be, for example, a nonwoven fabric, a film, a membrane, or the like. An example of a substrate feeder can be a spindle on which a beam of the substrate can be placed. The beam of the substrate can be created, for example, by wrapping the substrate on a center roll. The center roll can then be placed on the spindle and the spindle can then be rotated to permit the substrate to be removed from the beam and then fed between the die body and the collector. Another example of a substrate feeder is an upstream process that can be used to pre-treat or form the substrate.

The substrate can be combined with the fibers extruded from the die body to form a nonwoven laminate. An electric field can be generated between the die body and collector in the line. When used herein to describe the location of the electric field, the use of the phrase “between the die body and the collector” means being located at some position between the die body and the collector which might or might not include the actual die body and/or the collector. The electric field can help direct the fibers exiting the die body toward the collector as the substrate passes over the collector to collect the fibers on the substrate. The electric field can be created in different manners as will be explained in more detail below.

Using such nonwoven production lines and methods, a fiber coated nonwoven laminate can be created that comprises a substrate having a first surface and a fiber layer secured to the first surface of the substrate. The fiber layer can be uniformly distributed on the first surface of the substrate with the fiber layer having a weight per unit area between about 0.5 gsm and about 100 gsm. For example, the weight per unit area of the fiber layer can be between about 0.5 gsm and about 3 gsm. For instance, the weight per unit area of the fiber layer can be between about 0.5 gsm, about 0.6 gsm, about 0.7 gsm, about 0.8 gsm, about 0.9 gsm, about 1.0 gsm, about 1.1 gsm, about 1.2 gsm, about 1.3 gsm, about 1.4 gsm, about 1.5 gsm, about 1.6 gsm, about 1.7 gsm, about 1.8 gsm, about 1.9 gsm, about 2.0 gsm, about 2.1 gsm, about 2.2 gsm, about 2.3 gsm, about 2.4 gsm, about 2.5 gsm, about 2.6 gsm, about 2.7 gsm, about 2.8 gsm, about 2.9 gsm and about 3.0 gsm.

In such fiber coated nonwoven laminates, the substrate can comprise a non-porous substrate or a porous substrate. For example, the substrate can comprise a porous nonwoven fabric or a porous film or membrane. Additionally, the substrate can comprise a non-porous nonwoven fabric or a non-porous film or membrane. For example, the substrate can be generally impermeable to air. For instance, the substrate comprises an electrospun nano-fiber membrane.

The substrate as well as the fiber layer can be thin. For example, the substrate can be a film that has a thickness of about 0.01 mm. Additionally, the fiber layer, for example, can have a thickness of between about 0.005 mm and about 2 mm. Thus, the fiber coated nonwoven laminate can be thin as well. For example, the overall thickness of the fiber coated nonwoven laminate can be between about 0.015 mm and about 2 mm. For instance, in some cases the overall thickness of fiber coated nonwoven laminates can be about 0.02 mm, about 0.025 mm, about 0.03 mm, about 0.04 mm, about 0.05 mm, about 0.06 mm, about 0.07 mm, about 0.08 mm, about 0.09 mm, about 0.1 mm, about 0.5 mm, about 0.8 mm, about 1 mm, about 1.3 mm, about 1.5 mm, about 1.7 mm or about 1.9 mm.

In some embodiments of a fiber coated nonwoven laminate, an adhesive is not required to secure the fiber layer to the substrate. For example, the fiber layer can be secured to the substrate in a manner as described below that requires no adhesive to be applied between the substrate and the fiber layer.

Further features of the nonwoven laminates and the lines and the methods of making the nonwoven laminates are provided below.

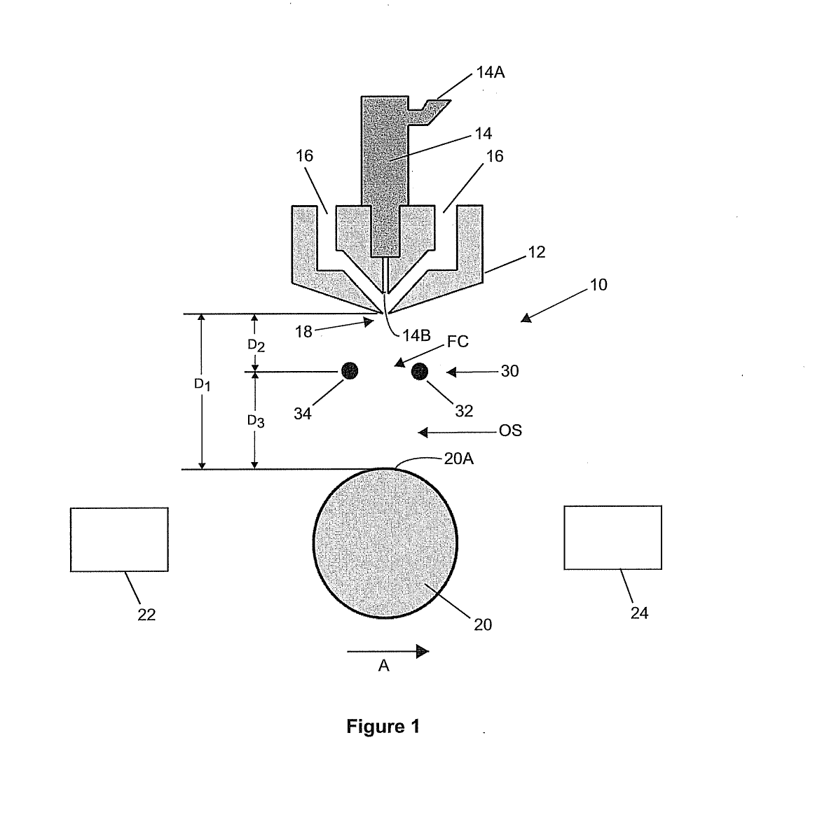

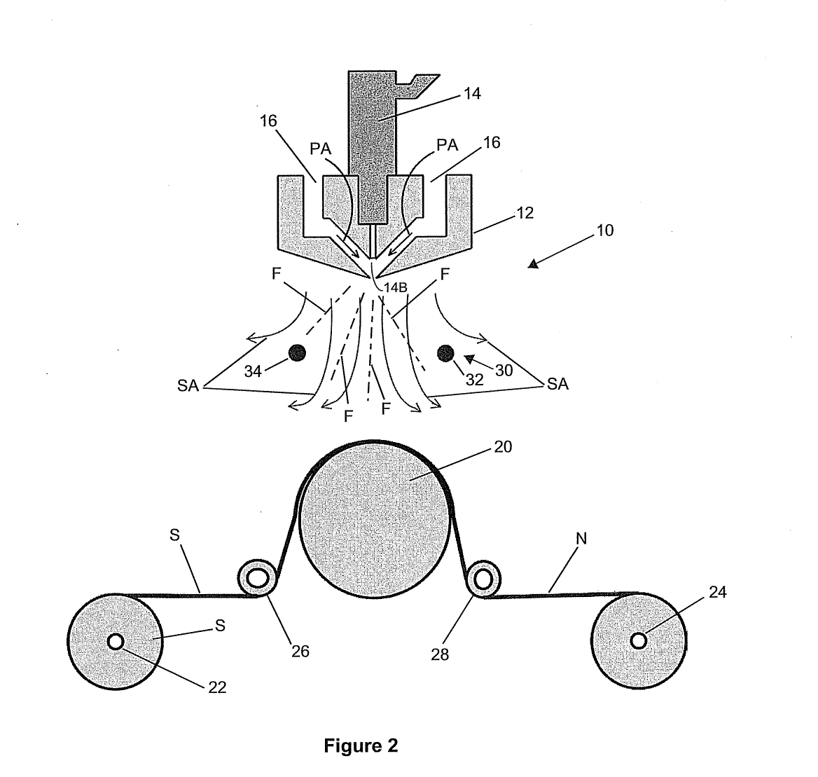

Referring now to the Figures, wherein like reference numerals refer to like parts throughout, FIGS. 1-7 illustrate different embodiments of lines used to manufacture the nonwoven laminates according to the present subject matter. These embodiments are provided to explain the subject matter and not as a limitation thereto. For example, FIG. 1 illustrates a line, generally designated 10, for forming a nonwoven laminate N (see FIGS. 2-7) according to the present subject matter is provided. Line 10 can comprise a die body 12 that can be used to create fibers F (see FIGS. 2-7). For example, a die body 12 can be a die body configured to produce spunbonded fibers or meltblown fibers.

In the embodiment shown in FIGS. 2-7, for example, die body 12 can be used to produce meltblown fibers. Die body 12 can include an extruder 14 therein for extruding fibers. Extruder 14 can include a feeder 14A for accepting polymer to be processed in the extruder 14 and a spinneret 14B through which the polymer can be extruded. The polymer can be provided, for example, in pellet or liquid form. For instance, the polymer can be provided in pellet form that is poured into a chute feeder, such as feeder 14A. In the embodiment shown, extruder 14 is heated to heat the polymer above its melting point. The melted polymer can then be extruded through a spinneret 14B at a base of extruder 14 to form fibers. Different polymers can be used in line 10. Extruder 14 can be heated to different temperatures depending on the type of polymer used. For example, polypropylene can be used as the polymer. Polypropylene can have a melting temperature of between about 160° C. and about 170° C. In such an embodiment where polypropylene is used as the polymer, the extruder 14 can be heated to about 250° C. to melt the polymer.

Die body 12 can also include one or more air chambers 16 that can be used to provide pressurized air flow at a base opening 18 of die body 12 from which spinneret 14B extrudes the fibers. The air flow can be a blast of air or other pressurized gas that can stretch and/or break the fibers being extruded. The speed of the air flow can draw and attenuate the fibers being extruded. The air or gas can be heated to more effectively attenuate the fibers. The air flow can thus be used to make finer fibers. In spunbonding processes, air can be provided to draw and attenuate the fibers, while the fibers can remain as a continuous filament. In such spunbonding processes, the angle and configuration of air chambers 16 relative to extruder 14 can be different from that shown. In meltblown processes, the air flow from air chambers 16 can be at such a speed and temperature that the fibers are drawn and broken into shorter length fibers. The meltblown fibers can be attenuated in a manner that the fibers are of a very small size in diameter.

The throughput of the polymer melt can be in the range of about 0.01 gram per hole per minute (hereinafter “ghm”) to about 5 ghm. For example, the throughput of the polymer melt can be in the range of about 0.05 ghm to about 2 ghm. Possible applications of the product depend on the type of substrate and the basis weights of the meltblown and spunbonded fabrics. For example, the basis weight of the meltblown or spunbonded fabric can be in ranges of about 0.3 gsm to about 100 gsm for filter media applications, about 0.3 gsm to about 20 gsm for application as back sheet of a diaper, and about 0.3 to about 10 gsm for battery separator applications.

Continuing with reference to FIG. 1, line 10 can further comprise a collector 20 disposed below die body 12 for collecting the fibers extruded therefrom. Collector 20 in some embodiments can have a voltage applied thereto to create an electrode. In other embodiments, collector 20 can be grounded. Collector 20 can comprise many structures and collector 20 can be rotatable. For example, as shown in FIG. 1, collector 20 can be a rotatable drum or a belt web former. Alternatively, collector 20 can be stationary.

Line 10 can comprise a substrate feeder 22 for directing a substrate S (see FIGS. 2-6) over collector 20 between die body 12 and collector 20. Such a substrate can be, for example, a nonwoven fabric, a film, a membrane or the like. An example of a substrate feeder 22 can be a spindle on which a beam of the substrate can be placed. In another example, substrate feeder 22 can be a production line that produces substrate S. For example, substrate feeder 22 can be an extrusion process for creating a film that can serve as a substrate S. Similarly, substrate feeder 22 can be a nonwoven line for creating a nonwoven substrate S. A take-up device 24 can also be provided to remove nonwoven laminate N (see FIGS. 2-6) formed by the substrate and the fibers collected thereon from collector 20 of line 10. Take-up device 24 can be, for example, a take-up roll that winds the formed nonwoven laminate onto a beam. The beam of formed nonwoven laminate can be moved or shipped to another location for further processing as needed. Alternatively, take-up device 24 can be a mechanism that moves the formed nonwoven laminate to another process step in making an end product. For example, take-up device 24 can be nip rollers, or a friction belt that facilitate movement of the formed nonwoven laminate in the direction A.

One or more charging devices can be provided to aid in creating an electric field between die body 12 and collector 20 in line 10. As shown in FIG. 1, a charging device 30 can be disposed between die body 12 and collector 20 to charge the fibers exiting extruder 14 and die body 12. Charging device 30 can comprise one or more electrodes. For example, as shown in FIG. 1, charging device 30 can comprise electrodes 32, 34. Electrodes 32, 34 can be positioned on either side of a fiber corridor FC between die body 12 and collector 20 in which the fibers are intended to travel. In the embodiment shown, charging device 30 and its electrodes 32, 34 can be used in such an embodiment of line 10 to create an electric field between die body 12 and collector 20 in line 10. In such an embodiment as shown in FIG. 1, charging device 30 can be disposed between die body 12 and collector 20 to charge the fibers. For example, charging device 30 can be disposed in the open space OS between die body 12 and collector 20. The electric field can help to direct the fibers exiting die body 12 toward collector 20 as the substrate passes over collector 20 to collect the fibers on the substrate.

Continuing with FIG. 1, charging device 30 can be used in conjunction with die body 12 and collector 20 to create the electric field. Electrodes 32, 34 of charging devices 30 can generate the charges either from the electrical field (such as from about 4 to about 15 kV/cm) between two electrodes 32, 34 or the electrical field (such as from about 4 to about 15 kV/cm) between die body 12 and charging device 30 or the electrical field (such as from about 4 to about 15 kV/cm) between charging device 30 and collector 20. For example, depending on whether and how electrodes 32, 34 of charging device 30 and/or collector 20 are charged, die body 12 can be grounded or charged. When die body 12 is charged, it can also be electrically isolated. Similarly, as stated above, collector 20 can have a voltage applied thereto to create an electrode. For example, a high voltage can be applied to collector 20. For instance, a positive voltage of about 35 kV can be applied on electrodes 32, 34 of charging device 30 under die body 12 and a negative voltage of about 40 kV can be applied to collector 20. Alternatively, collector 20 can be grounded, as will be explained in some of the embodiments below.

When creating an electric field, the strength of the electric field can be such that it reduces the opportunity for arcing between the created electrodes such as the electrodes of the charging device, the collector, and/or the die body. Similarly, the strength of the electric field can be great enough to create a coronal discharge. For example, in some embodiments, if electric fields are greater than 15 kV/cm, arcing can occur. Alternatively, in some embodiments, if electric fields are less than 4 kV/cm, coronal discharge can be insignificant. Thus, in some embodiments, the electric fields created in the line 10 can be between about 4 kV/cm and about 15 kV/cm, including about 4 kV/cm, about 5 kV/cm, about 6 kV/cm, about 7 kV/cm, about 8 kV/cm, about 9 kV/cm, about 10 kV/cm, about 11 kV/cm, about 12 kV/cm, about 13 kV/cm, about 14 kV/cm, and/or about 15 kV/cm.

In some embodiments, die body 12 can be positioned relative to collector 20 at a distance D₁ as measured from base opening 18 in die body 12 to a collection surface 20A of collector 20. Charging device 30 can be positioned between die body 12 and collector 20 at a distance of D₂ as measured from base opening 18 in die body 12 to a horizontal midpoint or axis of charging device 30. Similarly, charging device 30 can be positioned between die body 12 and collector 20 at a distance of D₃ as measured from collection surface 20A of collector 20 to a horizontal midpoint or axis of charging device 30.

The positioning of die body 12, collector 20 and charging device 30 relative to one another can influence the electric field created. For example, the ability of the electric field to aid in directing the fibers toward collector 20 can be affected by the distances between die body 12, collector 20 and charging device 30. The distances between die body 12, collector 20 and charging device 30 can vary. For example, distance of D₂ can be between about 1 cm and about 30 cm. For instance, distance of D₂ can be between about 4 cm and about 20 cm. Similarly, as an example, distance of D₃ can be between about 2 cm and about 60 cm. For instance, distance of D₃ can be between about 2 cm and about 45 cm. Thus, distance of D₁ can be between about 3 cm and about 90 cm. For instance, distance of D₁ can be between about 6 cm and about 65 cm. The electric field can be about 4 kV to about 15 kV per centimeter of distance between the respective components such as die body 12, collector 20 and charging device 30

FIG. 2 illustrates a line 10, as shown in FIG. 1, when no voltage is applied among die body 12, collector 20 and charging device 30. Without any electrostatic charging provided by electrodes 32, 34, die body 12 and/or collector 20 and no electric field created at some point between die body 12 and collector 20, fibers F extruded from extruder 14 might not be controllably collected and attached to substrate S. Thus, a uniform layer of fibers F to coat substrate S to create nonwoven laminate N is not likely to occur and cannot be consistently produced and/or replicated. This inconsistency is especially true when air flow is taken into consideration. For example, primary air flow PA provided through air chambers 16 attenuates and can possibly break the fibers and together with secondary air flow SA blow fibers F away from substrate S. In particular, the fibers can be of such a small weight and size, the forces created by primary and secondary air flows PA and SA can have a tendency to easily carry fibers F in the direction of travel of the air flow away from and around substrate S as it passes over collector 20.

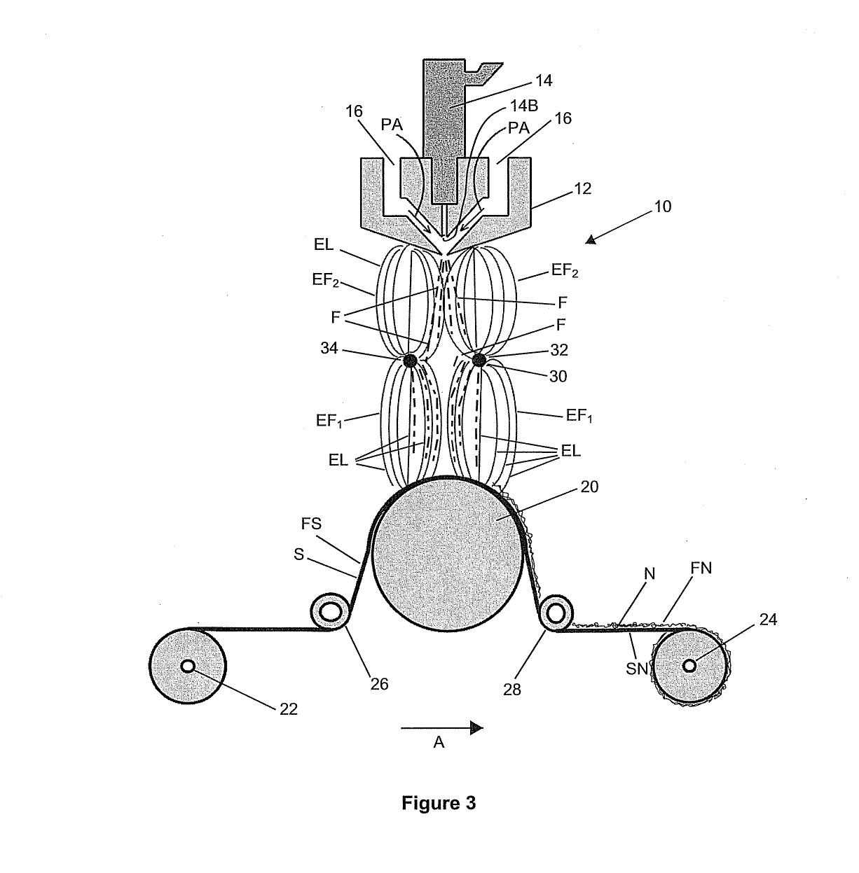

FIG. 3 illustrates a line 10, as shown in FIG. 1, when electrodes 32, 34 of charging device 30 are of the same polarity and die body 12 is grounded. Electric fields EF₁ can be created between the charging device 30 and the collector 20, when the charging device 30 and the collector 20 have opposite polarities. Also, electric fields EF₂ can be created between the charging device 30 and the grounded die body 12. In such an embodiment, for example, collector 20 can have a charge that is the opposite polarity from that of electrodes 32, 34 of charging device 30. For example, a positive voltage of about 35 kV can be applied on electrodes 32, 34 of charging device 30 under die body 12 and a high negative voltage of between about 40 kV and about 45 kV can be applied to collector 20. As the fibers F leave spinneret 14B of extruder 14, electric field lines EL can charge the fibers F. For example, fibers F can be charged to carry a monopolar charge or a bipolar charge. In such embodiments, charged fibers F can travel along the electric field lines EL of the electric fields EF₁, EF₂ to be collected on substrate S. For example, the electrical charge helps to attached fibers F to a first surface FS of substrate S to form nonwoven laminate N by directing fibers F to first surface FS of substrate S.

When fibers F are in the molten form, fibers F can adhere to first surface FS of substrate S to form a nonwoven laminate N. In this manner, the fiber web layer FN can be attached to substrate S in a manner that is chemically inert, since the fiber web layer FN can be attached to substrate S without an adhesive or other pretreatment. However, for some embodiments, as in some spunbonding and meltblowing processes, fibers can begin to solidify before they can contact on the substrate so as to limit the fibers ability to adhere to the substrate. In such instances, the substrate can be pre-treated to further facilitate attachment of the fibers to the substrate. The substrate can be pretreated by different methods and/or substances to facilitate attachment of such spunbonded or meltblown fibers to the substrate including, but not limited to application of adhesives, plasma treatment, chemical treatment, or the like.

For instance, an adhesive or plasma treatment can be applied on the first surface of the substrate to further facilitate attachment of such spunbonded fibers on that first surface to form the fiber coated nonwoven laminate. For example, the adhesive or plasma treatment can be applied to the first surface of the substrate at some point before the formation of the spunbonded fiber web layer on the substrate, so that the fiber coated nonwoven laminate is created as spunbonded fibers land on the substrate. Additionally, for meltblown embodiments, the adhesive or the plasma treatment can be applied to the surface of the substrate before the formation of the meltblown fibers if the fibers are solidified by, for instance, the large distance between the meltblowing die and the collector. For thin spunbonded fiber web layers, fibers can adhere to the surface of the substrate and further bonding is not needed. For thicker spunbonded fiber web layers, further bonding may be beneficial to bond the fibers. By extruding the spunbonded fibers and the guiding fibers toward the adhesive-covered surface of the substrate by one or more electric fields, a fiber coated nonwoven laminate can be easily formed in a single step. The electric fields reduce or prevent fly waste by directing the fibers toward the substrate that is passing over the collector so that more fibers adhere to the substrate.

Thus, continuing with FIG. 3, as substrate S leaves substrate feeder 22 in direction A, substrate S can pass under idle roller 26 (see also FIG. 2) and around collector 20. Fibers F can be collected on substrate S along electric field lines EL of electric fields EF₁ between charging device 30 and collector 20. The collection of fibers F on substrate S forms fiber coated nonwoven laminate N as fibers F stick to substrate S. Nonwoven laminate N can pass under idle roller 28 (see FIG. 2) and can be received by take-up device 24. Substrate feeder 22, idle rollers 26, 28, and take-up device 24 can work in tandem with one another along with collector 20 to ensure proper placement of substrate S on collector 20 relative to fibers F as fibers F travel towards collector 20. The position of substrate S on collector 20 and the manner in which fibers F travel along the electric fields EF₁, EF₂ facilitate uniform coverage of fibers F on substrate S to form nonwoven laminate N for a wide range of weights for a fiber layer FN that reside on substrate layer SN. For example, fiber layer FN can range between about 0.5 gsm to about 100 gsm. For instance, meltblown or spunbonded webs that make up such fiber web layer FN can be about 0.5 gsm to about 20 gsm. In some embodiments, the weight of fiber web layer FN can be about 0.5 gsm, about 0.6 gsm, about 0.7 gsm, about 0.8 gsm, about 0.9 gsm, about 1 gsm, about 2 gsm, about 3 gsm, about 4 gsm, or about 5 gsm, for example.

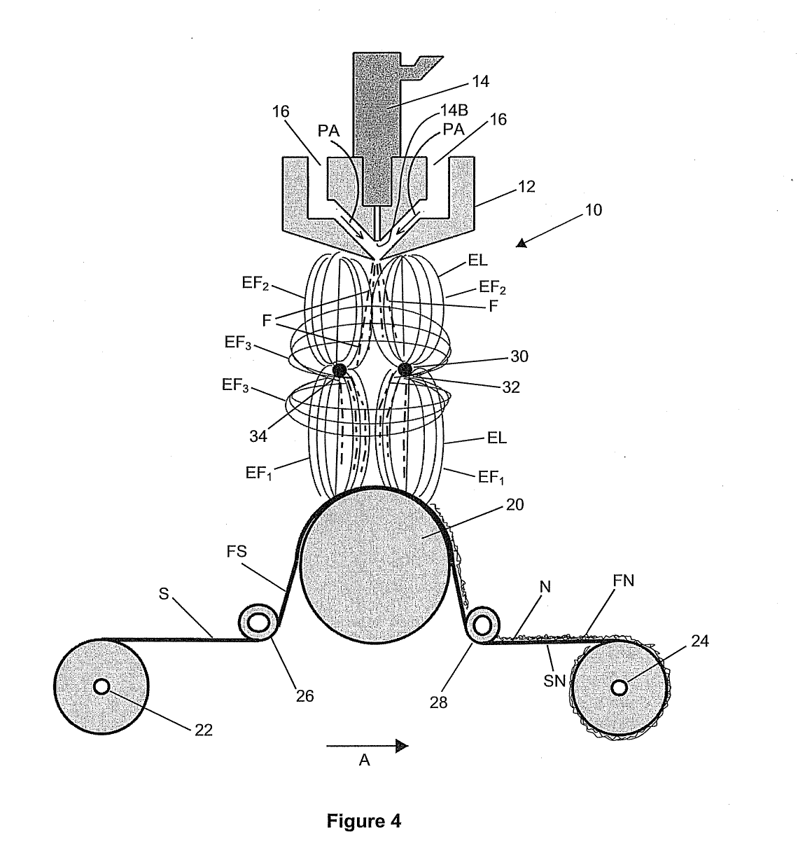

Substrate S can comprise a non-porous substrate or a porous substrate. For example, as stated above, a substrate S can be, for example, a nonwoven fabric, a film, a membrane or the like. For instance, substrate S can comprise a non-porous film. For example, substrate S can be generally impermeable to air. Similarly, substrate S can comprise an electrospun nano-fiber membrane. Alternatively, substrate S can comprise a porous nonwoven fabric, a film, a membrane or the like. FIG. 4 illustrates a line 10, as shown in FIG. 1, when electrodes 32, 34 of charging device 30 are of opposite polarities and die body 12 and collector 20 are grounded. Electric fields EF₂ can be created between the charging device 30 and grounded die body 12. Also, electric fields EF₁ can be created between charging device 30 and collector 20, when collector 20 is grounded. In such embodiments, electric fields EF₃ can be created between electrodes 32, 34 of charging device 30. If electric fields EF₃ between electrodes 32, 34 of charging device 30 are greater than 15 kV/cm arcing can occur. If electric fields EF₃ between electrodes 32, 34 of charging device 30 are less than 4 kV/cm, coronal discharge on charging device 30 can be insignificant. However, any electric field between charging device 30 and collector 20 can assist the collection of the fibers on the substrate. As above, fibers F are in the molten form and can stick to substrate S to form a nonwoven laminate N.

In such an embodiment, for example, collector 20 can have a charge that is the opposite polarity from that of electrodes 32, 34 of charging device 30. For example, a positive voltage of about 35 kV can be applied on electrodes 32, 34 of charging device 30 under die body 12 and a high negative voltage of between about 40 kV and about 45 kV can be applied to collector 20. As the fibers F leave spinneret 14B of extruder 14, electric field lines EL can pick up the fibers F. In such embodiments, fibers F can travel along the electric field lines EL of the electric fields EF₁, EF₂ to be collected on substrate S, for example, a first surface FS of substrate S. The electrical charge created on fibers F by the electrical fields helps attach fibers F to substrate S to form nonwoven laminate N by directing fibers F to substrate S. If fibers F are in the molten form when they land on substrate S on collector 20, they can adhere to substrate S as they cool to form a nonwoven laminate N.

Thus, as substrate S leaves substrate feeder 22 in direction A, substrate S can pass under idle roller 26 and around collector 20. Fibers F can be collected on substrate S along electric field lines EL of electric fields EF₁ between charging device 30 and collector 20. The collection of fibers F on substrate S forms fiber coated nonwoven laminate N. Nonwoven laminate N can pass under idle roller 28 and can be received by take-up device 24. Substrate feeder 22, idle rollers 26, 28, and take-up device 24 can work in tandem with one another along with collector 20 to ensure proper placement of substrate S on collector 20 relative to the fibers F as fibers F travel towards collector 20. The position of substrate S on collector 20 and the manner in which fibers F travel along the electric fields EF₁, EF₂ facilitate uniform coverage of fibers F on substrate S to form nonwoven laminate N for a wide range of weights for a fiber layer FN that reside on substrate layer SN. For example, fiber web layer FN can range between about 0.5 gsm to about 100 gsm. For example, meltblown or spunbonded webs that make up such fiber web layers can be about 0.5 gsm to about 20 gsm. For instance, the weight of the fiber web layer can be about 0.5 gsm, about 0.6 gsm, about 0.7 gsm, about 0.8 gsm, about 0.9 gsm, about 1 gsm, about 3 gsm, about 7 gsm, about 10 gsm, or about 15 gsm.

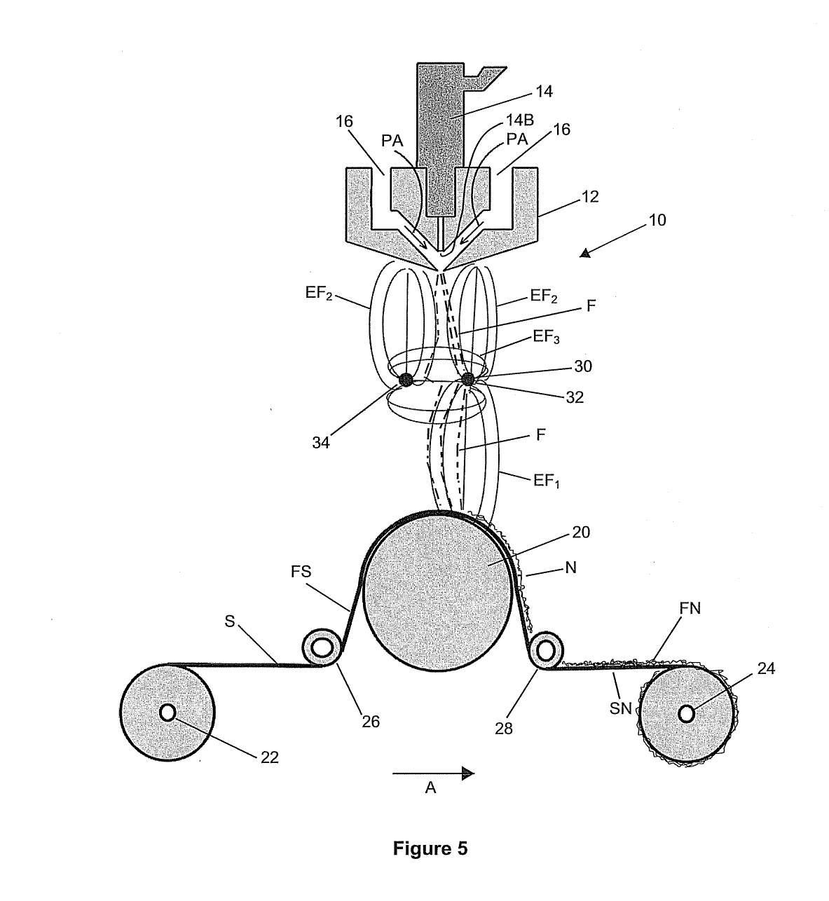

FIG. 5 illustrates a line 10, as shown in FIG. 1, when electrodes 32, 34 of charging device 30 are of opposite polarities and die body 12 is grounded and collector 20 is charged. In such embodiments, electric fields EF₃ can be created between electrodes 32, 34 of charging device 30. Electric fields EF₂ can be created between the charging device 30 and grounded die body 12. Since collector 20 is charged, an electric field EF₁ can be created between electrode 32 of charging device 30 and collector 20 because electrode 32 has an opposite polarity from the polarity of collector 20. However, since the other electrode 34 of charging device 30 has the same polarity of collector 20, no electric field is created between electrode 34 and collector 20. Thus, charges can be generated between the electrodes 32, 34 of charging device 30 and die body 12. Fibers F can travel along the electric field lines of electric field EF₁ between electrode 32 of charging device 30 and collector 20 to substrate S to collect on substrate S, for example, on a first surface FS of substrate S. As above, when fibers F are in the molten form, fibers F can adhere to substrate S to form a nonwoven laminate N.

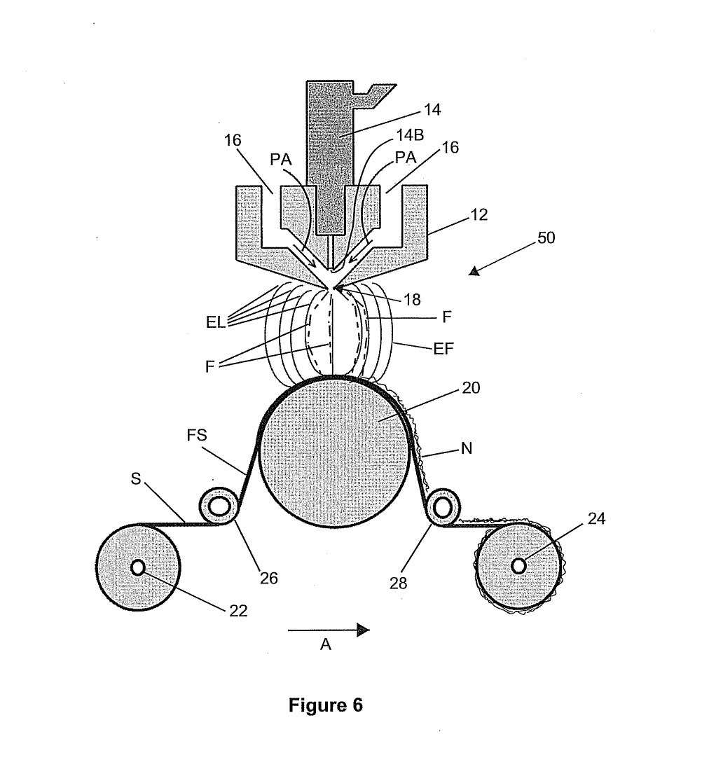

FIG. 6 illustrates a line, generally designated 50, for forming a nonwoven laminate N according to the present subject matter is provided.

Line 50 is similar to line 10 referred to above, except no charging device is provided. Line 50 can comprise a die body 12 that can be used to create fibers F. For example, die body 12 can be a die body configured to produce spunbonded fibers or meltblown fibers. Die body 12 can include an extruder 14 therein for extruding fibers. Die body 12 can also include one or more air chambers 16 that can be used to provide pressurized air flow PA at a base opening 18 of die body 12 from which the spinneret 14B extrudes the fibers. The air flow PA can be a blast of air or other pressurized gas that can stretch and/or break the fibers being extruded. For example, fibers in a meltblown process are often formed in this manner. The air or gas is heated to more effectively attenuate the fibers formed. Air flow PA draws and attenuates the fibers being extruded to make fine fibers. Line 50 can further comprise a collector 20 disposed below die body 12 for collecting the fibers extruded from die body 12.

As with line 10, line 50 can comprise a substrate feeder 22 for directing a substrate S over the collector 20 between die body 12 and the collector 20. Such a substrate can be, for example, a nonwoven fabric, a film, a membrane or the like. A take-up device 24 can also be provided to remove the nonwoven laminate N formed by the substrate and the fibers collected thereon from the collector 20 of the line 10.

As stated above, unlike line 10, line 50 does not include a charging device placed between die body 12 and collector 20. Instead, the electric field EF can be created between die body 12 and collector 20 without the presence of a charging device. In such embodiments, die body 12 can be charged, collector 20 can be charged or both die body 12 and collector 20 can be charged. If both die body 12 and collector 20 are charged, then die body 12 has a different polarity than collector 20. The charges may or may not be significant on fibers F but the electric field between die body 12 and collector 20, which, for example, can range from about 4 to about 15 kV per centimeters between die body 12 and collector 20, can be used to lay fibers F on substrate S as it passes over collector C. For example, fibers F can be directed to a first surface FS of substrate S by the electrical charge where fibers F can attach to substrate S to form nonwoven laminate N.

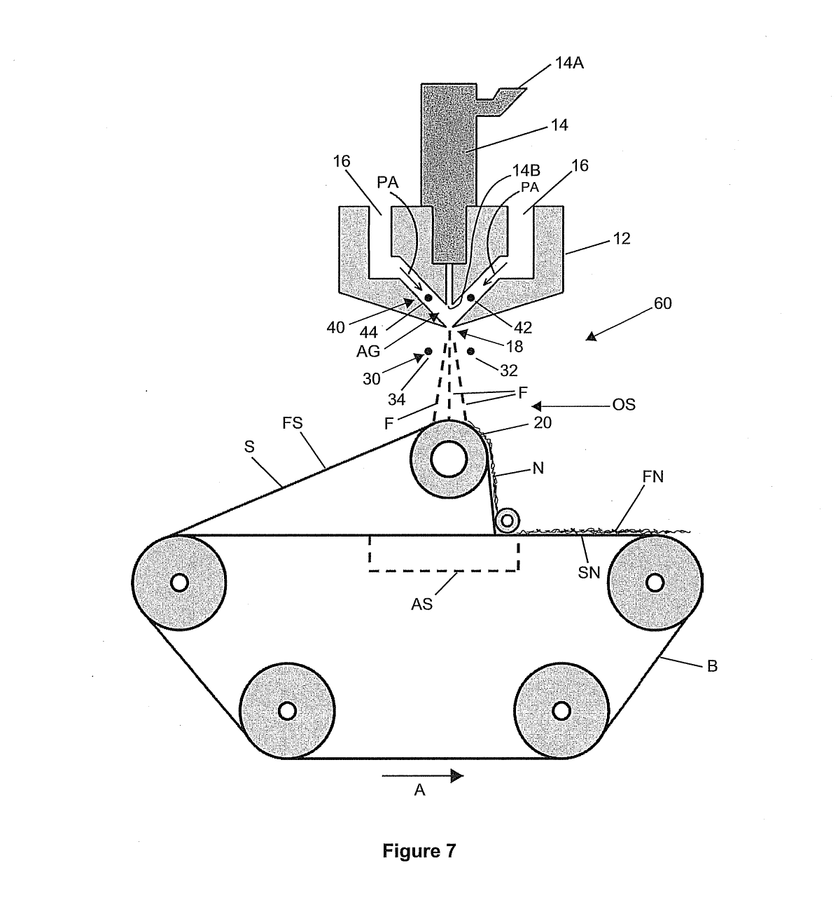

FIG. 7 illustrates further embodiment of a line, generally designated 60, for forming a nonwoven laminate N according to the present subject matter is provided. Line 60 provides a different transport for substrate S. In particular, line 60 provides a belt system that uses a belt B to facilitate transport of substrate S. Line 60 will now be described in more detail. Line 60 can comprise a die body 12 that can be used to create fibers F similar to those described above. As above, die body 12 can be a die body configured to produce spunbonded fibers and/or meltblown fibers. Die body 12 can include an extruder 14 therein for extruding fibers from polymer that can be fed into extruder 14 via a feeder 14A. The polymer can be provided by an upstream process, for example, a polymer forming process. Alternatively, the polymer can be provided, for example, in discrete form that can be fed into a funnel or chute feeder, such as feeder 14A. The extruder 14 can be heated to a temperature that is at or above the melting point of the polymer. The melted polymer can be extruded through a spinneret 14B at a base of the extruder 14 to form fibers F.

The die body 12 can also include one or more air chambers 16 that can be used to provided pressurized air flow PA at a base opening 18 of die body 12 from which the spinneret 14B extrudes the fibers. Air flow PA can be blasts of air or other pressurized gas that can stretch and/or break the fibers being extruded. In the embodiment shown, the air or gas from the air flow PA is heated to more effectively attenuate the fibers F. Air flow PA draws and attenuates the fibers.

Line 60 also illustrates a different way of charging the fibers and/or creating an electric field. Line 60 can also comprise two charging devices 30, 40 that can be used to charge fibers F and create an electric field. Charging device 30 can include two electrodes 32, 34 and charging device 40 can include two electrodes 42, 44. As shown, charging device 40 can reside within die body 12. For example, charging device 40 can reside within air chambers 16. For example, charging device 40 can be disposed in an air gap AG. Charging device 30 can be disposed in an open space OS between die body 12 and collector 20. Charging devices 30, 40 can be used to create an electrical field. Further, charging devices 30, 40 can be used in conjunction with die body 12 and collector 20 to create the electric field. For example, an electric field can be created between the charging devices 30, 40, and/or between the charging devices 30, 40 and die body 12, and/or between the charging devices 30, 40 and the collector 20.

For example, the electrodes 42, 44 of charging device 40 can have the same polarity. In this manner, charging device 40 can import a charge to fiber F exiting spinneret 14B. The electrodes 32, 34 of charging device 30 can also have the same polarity. However, the polarity of electrodes 42, 44 of charging device 40 can be different than the polarity of electrodes 32, 34 of charging device 30 to create an electric field therebetween. In such an example, die body 12 can be grounded, or electrically isolated and charged, and collector 20 can be charged or grounded. If charged, collector 20 can be a polarity that is different from the polarity of electrodes 32, 34 of charging device 30. Thus, as with line 10, line 60 can have many different configurations regarding how fibers F are charged and how electric fields are generated to facilitate the collection of fibers F on substrate S.

A belt B can be provided that runs under the substrate S. Belt B can have a first surface B₁. Belt B can be rotated so that substrate S moves in a direction of travel A. Belt B can facilitate transport of substrate S. In such an embodiment, a collector 20 can be suspended above belt B. Belt B can be configured to transport substrate S on first surface B₁ to a point where the substrate S can rise off of belt B and pass over collector C. In this manner, substrate S is configured to leave first surface B₁ of belt B and to pass over collector 20 to position substrate S for collection of fibers F thereon to form fiber web layer FN on the substrate to create the fiber coated nonwoven laminate N. For example, fibers F can be directed to a first surface FS of substrate S by the electrical charge where fibers F can attach to substrate S to form nonwoven laminate N. An idle roller 26A can be used to guide nonwoven laminate N back to belt surface B₁ of belt B. Also, in such an embodiment as line 60, an air suction device AS can optionally be positioned below belt B.

Thus, as illustrated above, different embodiments of nonwoven lines and nonwoven laminates can be provided. Without electrical charges or electric field, fibers F can have a tendency to blow away from substrate S by the air flows PA and SA within the system or line 10 as shown in FIG. 2. However, as illustrated in FIGS. 2-7, fibers F can be collected on substrate S with electrical charges on the fibers and/or electric field between die body 12 and charging device 30, charging device 30 and collector 20, or between die body 12 and collector 20 without charging device 30. Optimal or desirable electrostatic charging of the fibers and optimal or desirable electric field can be achieved by adjusting the voltages on charging device 30 and collector 20 depending on the processing parameters such as the primary air velocity, the distance between die body 12 to collector 20 (also known as the “DCD”—die to collector distance), and the polymer throughput. Additional guidance for such processing parameters can be found in the Example presented below.

In spunbonding processes, air is provided to draw and to attenuate the fibers, while the fibers can remain as a continuous filament. In addition, cooling air can be used to blow against the fibers as they are extruded. In such spunbonding processes, the angle and configuration of air chambers relative to the extruder can be different from that shown in the figures. The cooling air that is blown on the fibers as they are extruded can cause the outer surface of the fibers to harden quicker than in the interior of the fibers. In some embodiments that use spunbonded fibers, the substrate can be pre-treated to further facilitate attachment of the spunbonded fibers to the substrate. The substrate can be pretreated, for example, to facilitate attachment of such spunbonded fibers to the substrate. These pretreatments can include, but are not limited to plasma treatment, chemical treatment, adhesive treatment, or some other mechanical treatment.

For instance, an adhesive can be applied on the surface of the substrate on which the spunbonded fibers is to contact before the spunbonded fibers are spun thereon to further facilitate attachment of the spunbonded fibers to the substrate. By extruding the spunbonded fibers and guiding the fibers toward the adhesive-covered surface of the substrate by one or more electric fields, a fiber coated nonwoven laminate can be easily formed in a single step. For example, the adhesive can be applied to the face of the substrate at some point before the formation of the spunbonded fiber web layer on the substrate, so that the fiber coated nonwoven laminate is created as spunbonded fibers land on the substrate.

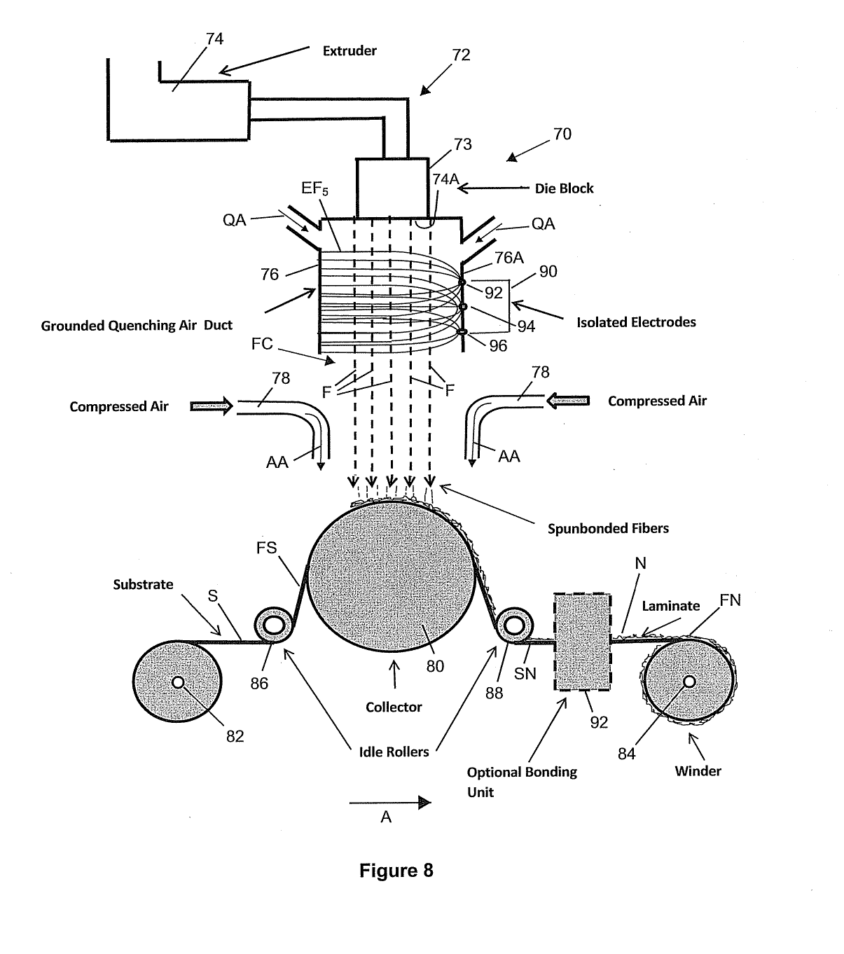

FIG. 8 illustrates a vertical cross-sectional schematic view of at least a portion of an embodiment of a spunbonding line for creating a nonwoven laminate according to the present subject matter. There are other possible configurations for forming spunbond webs that can be used to lay spunbonded fibers on a substrate with the aid of an electric field. This figure is provided to be representative of the use of a spunbonding process according to the present subject matter. The present subject matter should, thus, not be limited to the spunbonding process depicted in this figure, but also include other spunbonding processes and methods of creating an electric field. In FIG. 8, a spunbonded line, generally designated 70, for forming a nonwoven laminate N according to the present subject matter is provided. Line 70 can comprise a die body 72 that can be used to create fibers F. For example, a die body 72 can be a die body configured to produce spunbonded fibers.

Die body 72 can include a die block 73 and an extruder 74 therein for extruding fibers. Extruder 74 can include a feeder for accepting polymer to be processed in the extruder 74. In the embodiment shown, extruder 74 is heated to heat and/or maintain the polymer above its melting point. Extruder 74 feeds the polymer to the die block 73 where the polymer is extruded through a spinneret 74A. Spinneret 74A extrudes fibers F into a quenching air duct 76. Quenching air duct 76 extends downward from die block 73 and spinneret 74A and can provide a cooling airflow QA around the fibers F to cool the fibers F. Blow ducts 78 can be provided that produce an attenuating airflow AA to further draw and attenuate fibers F. For example, compressed air can be provided through the blow ducts 78 to create attenuating airflow AA.

Continuing with reference to FIG. 8, line 70 can comprise a collector 80 disposed below die body 72 for collecting the fibers extruded therefrom. Collector 80 in some embodiments can have a voltage applied thereto to create an electrode. In other embodiments, collector 80 can be grounded. Collector 80 can comprise many structures and collector 80 can be rotatable. For example, as shown in FIG. 8, collector 80 can be a rotatable drum or a belt web former. Alternatively, collector 80 can be stationary.

Line 70 can comprise a substrate feeder 82 for directing a substrate S (see FIGS. 2-6) over collector 80 between die body 72 and collector 80. Such a substrate can be, for example, a nonwoven fabric, a film, a membrane or the like. An example of a substrate feeder 82 can be a spindle on which a beam of the substrate can be placed. In another example, a substrate feeder can be a production line that produces substrate S. For example, a substrate feeder can be an extrusion process for creating a film that can serve as a substrate S. Similarly, a substrate feeder can be a nonwoven line for creating a nonwoven substrate S.

A take-up device 84 can also be provided to remove nonwoven laminate N formed by substrate S and fibers F collected thereon from collector 80 of line 70. Take-up device 84 can be, for example, a take-up roll that winds the formed nonwoven laminate onto a beam. The beam of formed nonwoven laminate can be moved or shipped to another location for further processing as needed. Alternatively, a take-up device can be a mechanism that moves the formed nonwoven laminate to another process step in making an end product. For example, a take-up device can be nip rollers, or a friction belt that facilitate movement of the formed nonwoven laminate in the direction A.

As shown in FIG. 8, a charging device 90 can be disposed between die body 72 and collector 80 to charge the fibers exiting die body 72. For example, charging device 90 can be disposed on a side 76A of a quenching air duct 76. In such embodiments, charging device 90 can be electrically isolated from quenching air duct 76 and die body 72. Charging device 90 can comprise one or more electrodes. For example, as shown in FIG. 8, charging device 90 can comprise electrodes 92, 94, 96. Electrodes 92, 94, 96 can be positioned on one side 76A of quenching air duct 76 between die body 72 and collector 80 in a fiber corridor FC where fibers F travel. In the embodiment shown, quenching air duct 76 can be grounded. Charging device 90 and its electrodes 92, 94, 96 can be used in such an embodiment of line 70 to create an electric field EF₅ between the electrodes 92, 94, 96 and the grounded quenching air duct 76 that resides between die body 72 and collector 80 in line 70. Electric field EF₅ can charge fibers F as they pass therethrough. In such an embodiment as shown in FIG. 8, collector 80 can be grounded also, so that charged fibers F are drawn toward collector 80. In this manner, electric field EF₅ can help to direct fibers F exiting die body 72 toward collector 80 as substrate S passes over collector 80 to collect fibers F on substrate S. For example, fibers F can collect on first surface FS of substrate S. Collector 80 can be charged to have opposite polarity than electrode 90 to create a stronger electrical field between electrode 90 and collector 80. This generates a higher attractive force to better collect fibers on substrate S.

Due to the spunbonding process, an optional bonding unit 92 can be provided to ensure or increase bonding of fiber layer FN to substrate layer SN to form a nonwoven laminate N. For example, bonding unit 92 can be a thermal bonding unit that causes a portion of the fiber layer to adhere to substrate S in a known manner. Alternatively, in some embodiments, an adhesive can be applied on first surface FS of substrate S on which spunbonded fibers F are to contact before spunbonded fibers F are spun thereon to further facilitate attachment of the spunbonded fibers F to substrate S. By extruding spunbonded fibers F and guiding fibers F toward first surface FS (which can optionally be adhesive-covered) of substrate S by one or more electric fields, a fiber coated nonwoven laminate N can be easily formed in a single step.

By using a nonwoven product line similar to the embodiments described above, a method of forming a fiber coated nonwoven laminate can be provided. The method can comprise providing a die body that includes an extruder for extruding fibers. An electric field can be created between the die body and a collector. The collector can be, for example, a drum that rotates during collection of the fibers on the substrate. To create the electric field, for example, one or more charging devices can be used. For instance, a charging device can be placed in an open space between the die body and the collector. Additionally, or alternatively, the collector disposed below the die body can be charged with a high voltage charge. Further, the die body can be grounded or electrically isolated and charged.

Thus, the electric field can vary in how it is created and in its size. For example, the electrodes of charging devices can generate the charges either from the electrical field (such as from about 4 to about 15 kV/cm) between the two electrodes or the electrical field (such as from about 4 to about 15 kV/cm) between the die body and the charging device or the electrical field (such as from about 4 to about 15 kV/cm) between the charging device and the collector. For example, if a positive voltage of 35 kV is applied to the charging device under the die body, then an electrical field of 7 kV/cm is generated based on a distance of 5 cm between the charging device and the die body. Similarly, a negative voltage of 40 kV can be applied to the collector then an electrical field of 8 kV/cm is generated based on a distance of 5 cm between the collector and the charging device. In some embodiments, a negative voltage of about 45 kV or higher can be applied to the collector. Again, the amount of voltage on the charging device can depend on the distance between the collector and the die body and the location of the charging device. Alternatively, either the die body or the collector can be charged and the electrical field (from about 4 to about 15 kV/cm) between the die body and the collector can generate the charges. The fibers can be charged to carry a monopolar charge or a bipolar charge.

A substrate can be fed over the collector and the fibers extruded from the die body as described above. The fibers can be directed toward the high voltage collector with the electric field created between the die body and the collector as the substrate passes over the collector. Such an electric field that is created at some point between the charging device and the collector can assist the collection of the fibers on the substrate. As above, the fibers are in a molten form and can stick to the substrate. In this manner, the electric field can facilitate the combining of the substrate and the fibers to form the nonwoven laminate.

Such electric fields can help create a uniform distribution of fibers to create a uniform fiber web layer on the substrate. For example, the fiber web layer can range between about 0.5 gsm and about 100 gsm. For example, meltblown or spunbonded webs that make up the fiber web layer can be about 0.5 gsm to about 20 gsm. The throughput of the polymer melt can be in the range of about 0.01 ghm to about 5 ghm. For example, as stated above, the polymer melt throughput can be in the range of about 0.05 ghm to about 2 ghm. Possible applications of the product depend on the type of substrate and the basis weights of the meltblown and spunbonded fabrics. For example, the basis weight of the meltblown or spunbonded fabric may be in ranges of about 0.3 gsm to about 100 gsm for filter media applications, about 0.3 gsm to about 20 gsm for application as back sheet of a diaper, and about 0.3 to about 10 gsm for battery separator applications.

### EXAMPLES

The following examples are provided to illustrate some of the nonwoven laminates and the results achieved using methods and lines that are the same or similar to those described above.

### Example 1

A trial was conducted using 15.0 grams per square meter (hereinafter “gsm”) PE porous film as a substrate. The polymer being extruded was Achieve 6936G1, a polypropylene homopolymer manufactured by ExxonMobil Corporation headquartered in Irving, Tex. (hereinafter “the polymer”). The polymer was extruded at a melt temperature of 480° F. and a throughput of 0.4 ghm (gram/hole/minute). The air temperature was about 490° F. with a primary air flow rate of 140 cubic feet per minute (hereinafter “cfm”). Both the charging device and the collector were charged. The voltage applied to both wires of the charging device was +40 kV, and the voltage applied to the collector was −45 kV. The collector was a rotatable drum. The distance between the die body and the collector was about 6.5 inches or about 16.5 centimeters. Meltblown fibers were blown and collected on the PE substrate moving across the top of the high voltage collector. Two basis weights, 5 gsm and 10 gsm, of the meltblown fabrics were made. The fibers were smoothly collected on the collector without fiber waste in the form of fly and the fibers had good bonding with the PE substrate.

### Example 2

A trial was conducted using the same substrate, meltblowing conditions and the meltblown fabric basis weights as Example 1. Both the charging device and the collector were charged. The voltage applied to both wires of the charging device was −40 kV. The voltage applied to the collector was +45 kV. The fibers were smoothly collected on the collector without measurable fiber waste in the form of fly and the fibers had good bonding with the PE substrate.

### Example 3

A trial was conducted using the same substrate, meltblowing conditions and the meltblown fabric basis weights as Example 2 except the voltage on one wire of the charging device was +18 kV and the voltage on the other wire of the charging device was −35 kV. The voltage on the collector was −50 kV. The fibers were smoothly collected on the collector with a small amount of fly, but the fibers had good bonding with the PE substrate.

### Example 4

A trial was conducted using the same substrate, meltblowing conditions and the meltblown fabric basis weights as Example 3 except the voltage applied to one wire of the charging device was +22 kV and the voltage applied to the other wire of the charging device was −20 kV. The voltage applied to the collector was +50 kV. The fibers were smoothly collected on the collector with a small amount of fly, but the fibers had good bonding with the PE substrate.

Through the use of the nonwoven production lines and methods described above, a uniform fiber web layer can be provided on a substrate that can be secured thereto, if desired without the use of an adhesive, to create a fiber coated nonwoven laminate. The weight of the fiber web layer can be in the range of about 0.5 gsm to about 100 gsm. Thus, such weights of about 0.5 gsm to about 3 gsm for fiber web layers in the fiber coated nonwoven laminate can be achieved that are not achievable with such nonwoven when adhesives are used to laminate fiber web layer to the substrate off the line. The fibers can be collected on the substrate with electrical charges on the fibers and/or electric field between the die body and the charging device, the charging device and the collector, or between the die body and the collector without the charging device. Optimal and/or desirable electrostatic charging of the fibers and optimal and/or desirable electric field can be achieved by adjusting the voltages on the charging device and the collector depending on the processing parameters such as the primary air velocity, the distance between the die body to the collector, and the polymer throughput.

The embodiments of the presently disclosed subject matter shown in the drawings and described above are exemplary of numerous embodiments that may be made within the scope of the appending claims. It is contemplated that numerous other configurations of the nonwoven laminates and methods and lines for making the same may comprise numerous materials other than those specifically disclosed.

What is claimed is:

1. A line for forming a nonwoven laminate, the line comprising:
a die body comprising an extruder therein for extruding fibers;
a collector disposed below the die body;
a substrate feeder for directing a substrate over the collector between the die body and the collector, the substrate being combinable with the extruded fibers to form the nonwoven laminate; and
an electric field being generatable between the die body and collector to direct the fibers toward the collector as the substrate passes over the collector to collect the fibers on the substrate.

2. The line according to claim 1, wherein the die body is grounded or charged.

3. The line according to claim 1, wherein the collector has a high voltage applied thereto to create an electrode.

4. The line according to claim 3, wherein a voltage of about 40 kV is applied to the collector.

5. The line according to claim 3, wherein a voltage of about 45 kV is applied to the collector.

6. The line according to claim 1, wherein the electrical field between the die body and the collector is from about 4 to about 15 kV/cm.

7. The line according to claim 1, further comprising a charging device disposed between the die body and the collector to charge the fibers.

8. The line according to claim 7, wherein the charging device is disposed in an open space between the die body and the collector.

9. The line according to claim 8, wherein a second charging device is disposed in an air gap between the die body and the collector.

10. The line according to claim 9, wherein a positive voltage of about 35 kV is applied on both the charging device under the die body and a negative voltage of about 40 kV is applied to the collector.

11. The line according to claim 7, wherein the charging device comprise two or more electrodes and electrical field between the electrodes is from about 4 to about 15 kV/cm.

12. The line according to claim 7, wherein the electrical field between the charging device and the collector is from about 4 to about 15 kV/cm.

13. The line according to claim 7, wherein the electrical field between the die body and the charging device is from about 4 to about 15 kV/cm.

14. The line according to claim 1, wherein the fibers are charged to carry a monopolar charge or a bipolar charge.

15. The line according to claim 1, wherein the substrate comprises a non-porous substrate or a porous substrate.

16. The line according to claim 1, wherein the substrate comprises a film or an electrospun nano-fiber membrane.

17. The line according to claim 1, further comprising a belt on which the substrate can be transported.

18. The line according to claim 1, wherein the line comprises meltblown nonwoven line.

19. The line according to claim 1, wherein the line comprises spunbonding nonwoven line.

20. A method for forming a nonwoven laminate, the method comprising:
providing a die body that comprises an extruder for extruding fibers;
creating an electric field located between the die body and a collector;
feeding a substrate over the collector;
extruding the fibers from the die body; and
directing the fibers toward the collector with the electric field located between the die body and the collector as the substrate passes over the collector so that the substrate and the fibers combine to form the nonwoven laminate.

21. The method according to claim 20, further comprising grounding the die body.

22. The method according to claim 20, further comprising electrically isolating the die body and charging the die body.

23. The method according to claim 20, wherein the step of creating an electric field further comprises charging a collector disposed below the die body with a high voltage to create an electric field between the die body and collector.

24. The method according to claim 20, further comprising charging the fibers between the die body and the collector with at least one charging device.

25. The method according to claim 24, further comprising placing the charging device in the open space between the die body and the collector.

26. The method according to claim 24, wherein a positive voltage of about 35 kV is applied by the at least one charging device under the die body and the high voltage applied to the collector is negative of about 40 kV.

27. The method according to claim 24, further comprising charging the fibers to carry at least one of a monopolar charge or a bipolar charge.

28. The method according to claim 20, further comprising applying a negative voltage of about 40 kV to the collector.

29. The method according to claim 20, further comprising applying a negative voltage of about 45 kV to the collector.

30. The method according to claim 20, further comprising moving the substrate on a belt toward the collector.

31. A fiber coated nonwoven laminate comprising:
a substrate having a first surface;
a fiber layer secured to the first surface of the substrate, the fiber layer being uniformly distributed on the first surface of the substrate; and
the fiber layer having a weight per unit area of between about 0.5 gram/m² and about 5 grams/m².

32. The fiber coated nonwoven laminate according to claim 31, wherein the substrate comprises a non-porous substrate.

33. The fiber coated nonwoven laminate according to claim 31, wherein the substrate comprises a porous substrate.

34. The fiber coated nonwoven laminate according to claim 31, wherein the substrate comprises an electrospun nano-fiber membrane.

35. The fiber coated nonwoven laminate according to claim 31, wherein the substrate comprises a film. 10

36. The fiber coated nonwoven laminate according to claim 31, wherein film has a thickness of about 0.02 mm.

37. The fiber coated nonwoven laminate according to claim 31, wherein the fiber layer has a weight per unit area of between about 0.5 gram/m² and about 3 grams/m².

38. The fiber coated nonwoven laminate according to claim 31, wherein the fiber layer has a weight per unit area of between about 0.5 gram/m² and about 2 grams/m².

39. The fiber coated nonwoven laminate according to claim 31, wherein the fiber layer has a thickness of between about 0.005 mm and about 2 mm.

40. The fiber coated nonwoven according to claim 31, wherein the overall thickness of fiber coated nonwoven laminate is between about 0.02 mm and about 0.25 mm.

41. The fiber coated nonwoven laminate according to claim 31, wherein the overall thickness of the fiber coated nonwoven laminate is equal to or less than about 0.03 mm.

42. The fiber coated nonwoven laminate according to claim 31, wherein the fiber layer comprises meltblown fibers.

43. The fiber coated nonwoven laminate according to claim 31, wherein no adhesive is used to secure the fiber layer to the substrate.
